(19) United States
(12) Patent Application Publication
(10) Pub. No.: US 2018/0049149 A1
(43) Pub. Date: Feb. 15, 2018

(54) METHOD FOR DETERMINING LOCATION OR MEASURING REFERENCE SIGNAL FOR DETERMINING LOCATION IN WIRELESS COMMUNICATION SYSTEM AND DEVICE FOR SAME

(71) Applicant: LG ELECTRONICS INC., Seoul (KR)

(72) Inventors: Hyunho Lee, Seoul (KR); Hyukjin Chae, Seoul (KR)

(21) Appl. No.: 15/556,354

(22) PCT Filed: Apr. 7, 2016
(86) PCT No.: PCT/KR2016/003642

§ 371 Date: Sep. 7, 2017

Related U.S. Application Data
(60) Provisional application No. 62/144,872, filed on Apr. 8, 2015.
(60) Provisional application No. 62/206,296, filed on Aug. 18, 2015.

(51) Int. Cl. H04W 64/00; H04L 5/00; H04W 24/10

(52) U.S. Cl. CPC H04W 64/00; H04W 24/10; H04L 5/0048; H04W 88/08

(57) ABSTRACT

A reference signal measurement method for determining a location in a wireless communication system, according to an embodiment of the present invention, is performed by means of a terminal. The method comprises the steps of: the terminal transmitting to a location server a report which relates to the capability for measuring a precoded reference signal (RS) for determining a vertical location; receiving, from the location server, configuration information for measuring the precoded RS; and measuring the precoded RS with respect to the configuration information and reporting the result thereof to the location server, wherein the configuration information can comprise a frequency or time domain for measuring the precoded RS by the terminal, a base station transmitting the precoded RS that is to be reported by the terminal, or information about the precoded RS that is to be reported by the terminal.

### TECHNICAL FIELD

The present invention relates to a wireless communication system, and more particularly, to a method of measuring a reference signal for determining a location or determining a location in a wireless communication system and an apparatus therefor.

### BACKGROUND ART

Recently, various devices requiring machine-to-machine (M2M) communication and high data transfer rate, such as smartphones or tablet personal computers (PCs), have appeared and come into widespread use. This has rapidly increased the quantity of data which needs to be processed in a cellular network. In order to satisfy such rapidly increasing data throughput, recently, carrier aggregation (CA) technology which efficiently uses more frequency bands, cognitive ratio technology, multiple antenna (MIMO) technology for increasing data capacity in a restricted frequency, multiple-base-station cooperative technology, etc. have been highlighted. In addition, communication environments have evolved such that the density of accessible nodes is increased in the vicinity of a user equipment (UE). Here, the node includes one or more antennas and refers to a fixed point capable of transmitting/receiving radio frequency (RF) signals to/from the user equipment (UE). A communication system including high-density nodes may provide a communication service of higher performance to the UE by cooperation between nodes.

A multi-node coordinated communication scheme in which a plurality of nodes communicates with a user equipment (UE) using the same time-frequency resources has much higher data throughput than legacy communication scheme in which each node operates as an independent base station (BS) to communicate with the UE without cooperation.

A multi-node system performs coordinated communication using a plurality of nodes, each of which operates as a base station or an access point, an antenna, an antenna group, a remote radio head (RRH), and a remote radio unit (RRU). Unlike the conventional centralized antenna system in which antennas are concentrated at a base station (BS), nodes are spaced apart from each other by a predetermined distance or more in the multi-node system. The nodes can be managed by one or more base stations or base station controllers which control operations of the nodes or schedule data transmitted/received through the nodes. Each node is connected to a base station or a base station controller which manages the node through a cable or a dedicated line.

The multi-node system can be considered as a kind of Multiple Input Multiple Output (MIMO) system since dispersed nodes can communicate with a single UE or multiple UEs by simultaneously transmitting/receiving different data streams. However, since the multi-node system transmits signals using the dispersed nodes, a transmission area covered by each antenna is reduced compared to antennas included in the conventional centralized antenna system. Accordingly, transmit power required for each antenna to transmit a signal in the multi-node system can be reduced compared to the conventional centralized antenna system using MIMO. In addition, a transmission distance between an antenna and a UE is reduced to decrease in pathloss and enable rapid data transmission in the multi-node system. This can improve transmission capacity and power efficiency of a cellular system and meet communication performance having relatively uniform quality regardless of UE locations in a cell. Further, the multi-node system reduces signal loss generated during transmission since base station(s) or base station controller(s) connected to a plurality of nodes transmit/receive data in cooperation with each other. When nodes spaced apart by over a predetermined distance perform coordinated communication with a UE, correlation and interference between antennas are reduced. Therefore, a high signal to interference-plus-noise ratio (SINR) can be obtained according to the multi-node coordinated communication scheme.

Owing to the above-mentioned advantages of the multi-node system, the multi-node system is used with or replaces the conventional centralized antenna system to become a new foundation of cellular communication in order to reduce base station cost and backhaul network maintenance cost while extending service coverage and improving channel capacity and SINR in next-generation mobile communication systems.

### DISCLOSURE OF THE INVENTION

### Technical Task

A technical task of the present invention is to provide a method of receiving a reference signal for determining a location or determining a location in a wireless communication system and an operation related to the method.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a method of measuring a reference signal for positioning, which is performed by a terminal in a wireless communication system, includes transmitting a report on a measurement capability of a precoded reference signal (RS) for determining a vertical position to a location server, receiving configuration information for measuring the precoded RS from the location server, and measuring the precoded RS according to the configuration information and reporting on a result of the measurement to the location server. In this case, the configuration information may include information on a time or frequency domain in which the precoded RS is to be measured by the terminal, a base station which transmits a precoded RS to be reported by the terminal, and the precoded RS to be reported by the terminal.

Additionally or alternatively, the method may further include receiving the configuration information for measuring the precoded RS from a serving base station.

Additionally or alternatively, the configuration information for measuring the precoded RS may include an identifier of each base station which transmits a precoded RS.

Additionally or alternatively, the identifier may be reported together with a measurement result of the precoded RS.

Additionally or alternatively, the method may further include reporting an identifier of the precoded RS measured by the terminal.

Additionally or alternatively, the configuration information for measuring the precoded RS may be provided to the location server from each base station which transmits a precoded RS.

Additionally or alternatively, information on a vertical beam applied to the precoded RS is transmitted to the location server and the vertical position of the terminal may be calculated based on the information on the vertical beam.

To further achieve these and other advantages and in accordance with the purpose of the present invention, according to a different embodiment, a method for positioning, which is performed by a location server in a wireless communication system, includes receiving a report on a measurement capability of a precoded reference signal (RS) for determining a vertical position of a terminal from the terminal, transmitting configuration information for measuring the precoded RS to the terminal, receiving a measurement result of the precoded RS measured by the terminal according to the configuration information, and determining the vertical position of the terminal using the measurement result and information on a vertical beam applied to the precoded RS corresponding to the measurement result. In this case, the configuration information may include information on a time or frequency domain in which the precoded RS is to be measured by the terminal, information on a base station which transmits a precoded RS to be reported by the terminal, and information on the precoded RS to be reported by the terminal.

Additionally or alternatively, the method may further include receiving the configuration information for measuring the precoded RS from an eNB transmitting each precoded RS.

Additionally or alternatively, the configuration information for measuring the precoded RS may include an identifier of each base station which transmits a precoded RS.

Additionally or alternatively, the method may further include receiving information on a vertical beam applied to the precoded RS from each base station which transmits a precoded RS.

Additionally or alternatively, the method may further include receiving a report on a transmission capability of the precoded RS from each base station which transmits a precoded RS.

Additionally or alternatively, the measurement result may include an identifier of the base station, which has transmitted the precoded RS measured by the terminal.

Additionally or alternatively, the method may further include receiving an identifier of the precoded RS measured by the terminal.

To further achieve these and other advantages and in accordance with the purpose of the present invention, according to a further different embodiment, a terminal configured to measure a reference signal for positioning in a wireless communication system includes an radio frequency (RF) unit and a processor that controls the RF unit, wherein the processor may control to transmit a report on a measurement capability of a precoded reference signal (RS) for determining a vertical position of the terminal to a location server, control to receive configuration information for measuring the precoded RS from the location server, measure the precoded RS according to the configuration information and report on a result of the measurement to the location server. In this case, the configuration information may include information on a time or frequency domain in which the precoded RS is to be measured by the terminal, information on a base station which transmits a precoded RS to be reported by the terminal, and the precoded RS to be reported by the terminal.

To further achieve these and other advantages and in accordance with the purpose of the present invention, according to a further different embodiment, a location server configured to determine a location of a terminal in a wireless communication system includes an radio frequency (RF) unit and a processor controls the RF unit, wherein the processor may control the RF unit to receive a report on a measurement capability of a precoded reference signal (RS) for determining a vertical location of a terminal from the terminal, control the RF unit to transmit configuration information for measuring the precoded RS to the terminal, control the RF unit to receive a measurement result of the precoded RS measured by the terminal according to the configuration information, determine the vertical position of the terminal using the measurement result and information on a vertical beam applied to the precoded RS corresponding to the measurement result. In this case, the configuration information may include information on a time or frequency domain in which the precoded RS is to be measured by the terminal, a base station which transmits a precoded RS to be reported by the terminal, and the precoded RS to be reported by the terminal.

Technical solutions obtainable from the present invention are non-limited the above-mentioned technical solutions. And, other unmentioned technical solutions can be clearly understood from the following description by those having ordinary skill in the technical field to which the present invention pertains.

### Advantageous Effects

According to one embodiment of the present invention, it is able to increase accuracy of determining a location in a wireless communication system and efficiently perform a procedure associated with location determination.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram for an example of a radio frame structure used in a wireless communication system;

FIG. 2 is a diagram for an example of a downlink (DL)/uplink (UL) slot structure in a wireless communication system;

FIG. 3 is a diagram for an example of a downlink (DL) subframe structure used in 3GPP LTE/LTE-A system;

FIG. 4 is a diagram for an example of an uplink (UL) subframe structure used in 3GPP LTE/LTE-A system;

FIG. 5 is a diagram for a PRS transmission structure;

FIGS. 6 and 7 are diagrams for RE mapping of a PRS (positioning reference signal);

FIG. 8 is a diagram for a shape of a beam according to 2D array antenna structure;

FIG. 9 illustrates vertical positioning of a UE according to one embodiment of the present invention;

FIG. 10 illustrates vertical positioning of a UE according to one embodiment of the present invention;

FIG. 11 is a flowchart for an operation according to an embodiment of the present invention;

FIG. 12 is a block diagram of a device for implementing embodiment(s) of the present invention.

### BEST MODE

### Mode for Invention

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlike a conventional centralized antenna system (CAS) (i.e. single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g., macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

In a multi-node system according to the present invention, which will be described below, one or more eNBs or eNB controllers connected to plural nodes can control the plural nodes such that signals are simultaneously transmitted to or received from a UE through some or all nodes. While there is a difference between multi-node systems according to the nature of each node and implementation form of each node, multi-node systems are discriminated from single node systems (e.g. CAS, conventional MIMO systems, conventional relay systems, conventional repeater systems, etc.) since a plurality of nodes provides communication services to a UE in a predetermined time-frequency resource. Accordingly, embodiments of the present invention with respect to a method of performing coordinated data transmission using some or all nodes can be applied to various types of multi-node systems. For example, a node refers to an antenna group spaced apart from another node by a predetermined distance or more, in general. However, embodiments of the present invention, which will be described below, can even be applied to a case in which a node refers to an arbitrary antenna group irrespective of node interval. In the case of an eNB including an X-pole (cross polarized) antenna, for example, the embodiments of the preset invention are applicable on the assumption that the eNB controls a node composed of an H-pole antenna and a V-pole antenna.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming). DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowledgement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

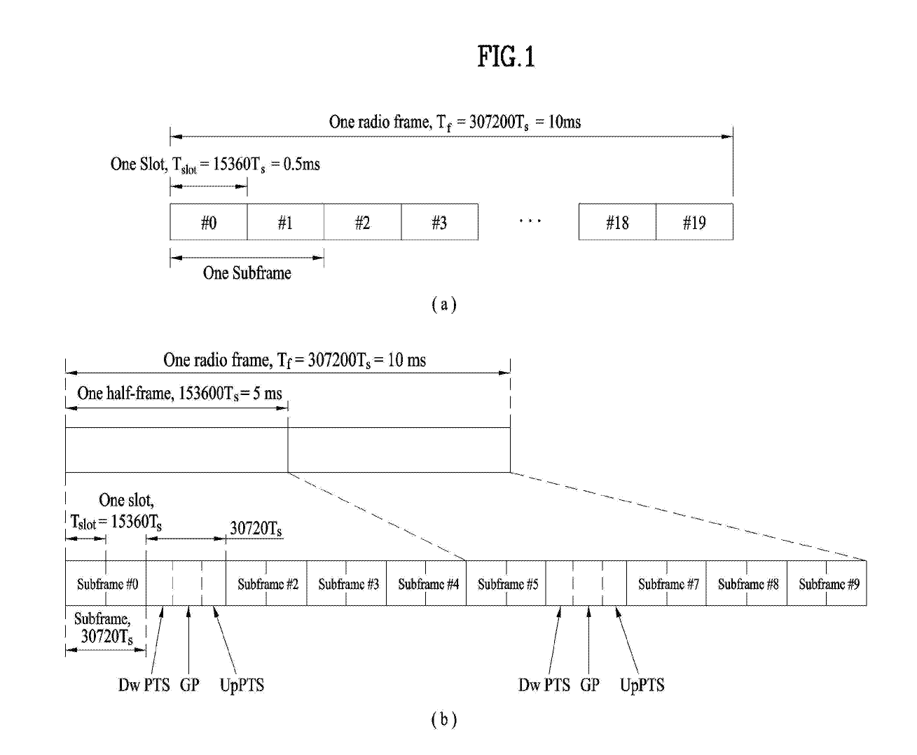

FIG. 1 illustrates an exemplary radio frame structure used in a wireless communication system. FIG. 1(a) illustrates a frame structure for frequency division duplex (FDD) used in 3GPP LTE/LTE-A and FIG. 1(b) illustrates a frame structure for time division duplex (TDD) used in 3GPP LTE/LTE-A.

Referring to FIG. 1, a radio frame used in 3GPP LTE/LTE-A has a length of 10 ms (307200 Ts) and includes 10 subframes in equal size. The 10 subframes in the radio frame may be numbered. Here, Ts denotes sampling time and is represented as Ts=1/(2048*15 kHz). Each subframe has a length of 1 ms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink-to- | | | | | | | | | | |
|---|---|---|---|---|---|---|---|---|---|---|---|
| DL-UL | Uplink Switch- | | | | | | | | | | |
| configu- | point period- | Subframe number | | | | | | | | | |
| ration | icity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | Normal cyclic prefix in downlink | | | Extended cyclic prefix in downlink | | |
|---|---|---|---|---|---|---|
| | | UpPTS | | | UpPTS | |
| Special | | Normal cyclic | Extended cyclic | | Normal cyclic | Extended cyclic |
| subframe | | prefix in | prefix in | | prefix in | prefix in |
| configuration | DwPTS | uplink | uplink | DwPTS | uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

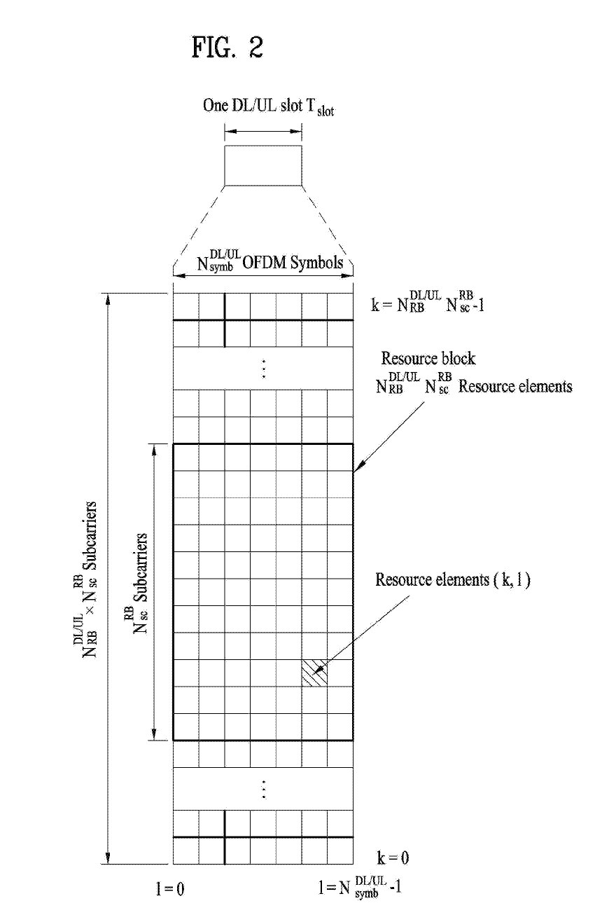

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, N_{RB}^{DL} denotes the number of RBs in a downlink slot and N_{RB}^{UL} denotes the number of RBs in an uplink slot. N_{RB}^{DL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g., 7) consecutive OFDM symbols in the time domain and N_{sc}^{RB} (e.g., 12) consecutive subcarriers in the frequency domain. For reference, a resource composed by an OFDM symbol and a subcarrier is called a resource element (RE) or a tone. Accordingly, an RB is composed of N_{symb}^{DL/UL}*N_{sc}^{RB} REs. Each RE in a resource grid can be uniquely defined by an index pair (k, l) in a slot. Here, k is an index in the range of 0 to N_{symb}^{DL/UL}*N_{sc}^{RB}−1 in the frequency domain and l is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, nPRB=nVRB is obtained. Numbers are given to the localized VRBs from 0 to N_{VRB}^{DL}−1, and N_{VRB}^{DL}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

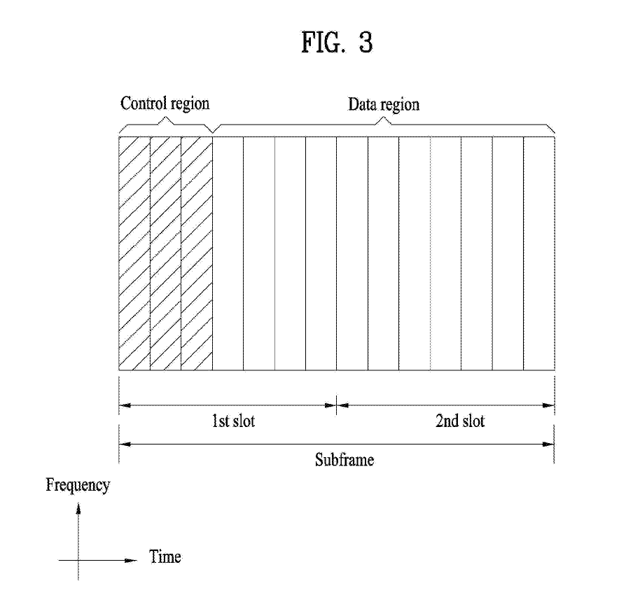

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. Aggregation levels defining the search space is as follows.

TABLE 3

| | | | Number of |
|---|---|---|---|
| Search Space | | | PDCCH |
| Type | Aggregation Level L | Size [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

A PDCCH candidate corresponds to 1, 2, 4 or 8 CCEs according to CCE aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g., frequency position) of “B” and transmission format information (e.g., transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

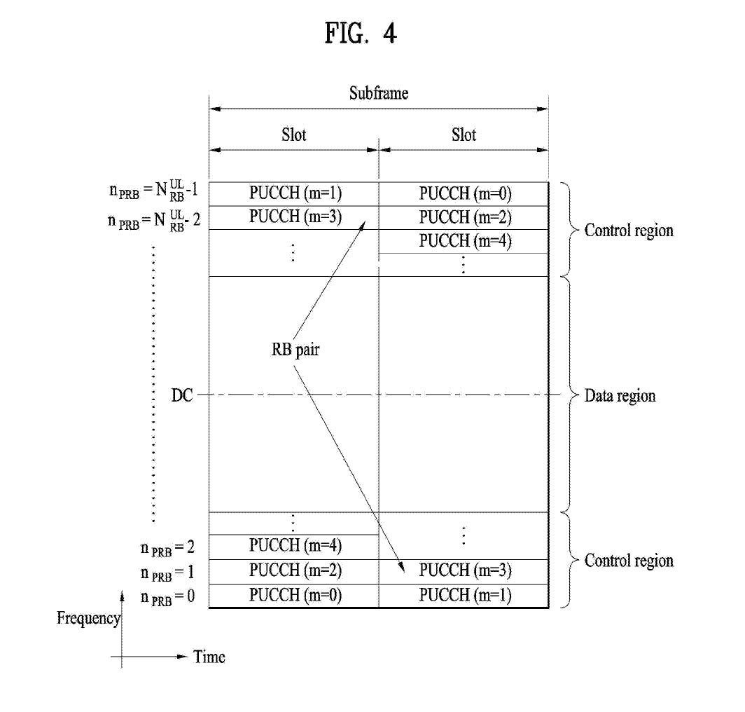

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency f0 during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.
Scheduling Request (SR): This is information used to request a UL-SCH resource and is transmitted using On-Off Keying (OOK) scheme.
HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (NACK), discontinuous transmission (DTX) and NACK/DTX. Here, the term HARQ-ACK is used interchangeably with the term HARQ ACK/NACK and ACK/NACK.
Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon.

Table 4 shows the mapping relationship between PUCCH formats and UCI in LTE/LTE-A.

TABLE 4

| | | Number | | |
|---|---|---|---|---|
| | | of bits per | | |
| PUCCH | Modulation | subframe, | | |
| format | scheme | M _{bit} | Usage | Etc. |
| 1 | N/A | N/A | SR (Scheduling | |
| | | | Request) | |
| 1a | BPSK | 1 | ACK/NACK | One codeword |
| | | | or SR + ACK/ | |
| | | | NACK | |
| 1b | QPSK | 2 | ACK/NACK | Two codeword |
| | | | or SR + ACK/ | |
| | | | NACK | |
| 2 | QPSK | 20 | CQI/PMI/RI | Joint coding |
| | | | | ACK/NACK |
| | | | | (extended CP) |
| 2a | QPSK + BPSK | 21 | CQI/PMI/RI + | Normal CP |
| | | | ACK/NACK | only |
| 2b | QPSK + QPSK | 22 | CQI/PMI/RI + | Normal CP |
| | | | ACK/NACK | only |
| 3 | QPSK | 48 | ACK/NACK | |
| | | | or SR + ACK/ | |
| | | | NACK or | |
| | | | CQI/PMI/RI + | |
| | | | ACK/NACK | |

Referring to Table 4, PUCCH formats 1/1a/1b are used to transmit ACK/NACK information, PUCCH format 2/2a/2b are used to carry CSI such as CQI/PMI/RI and PUCCH format 3 is used to transmit ACK/NACK information.

Generally, in a cellular communication system, various methods for acquiring position information of a UE in a network are used. Representatively, a positioning scheme based on OTDOA (observed time difference of arrival) exists in the LTE system. According to the positioning scheme, the UE may be configured to receive PRS (positioning reference signal) transmission related information of eNBs from a higher layer signal, and may transmit a reference signal time difference (RSTD) which is a difference between a reception time of a PRS transmitted from a reference eNB and a reception time of a PRS transmitted from a neighboring eNB to a eNB or network by measuring PRS transmitted from cells in the periphery of the UE, and the network calculates a position of the UE by using RSTD and other information. In addition, other schemes such as an A-GNSS (Assisted Global Navigation Satellite System) positioning scheme, an E-CID (Enhanced Cell-ID) scheme, and a UTDOA (Uplink Time Difference of Arrival) exist, and various location-based services (for example, advertisements, position tracking, emergency communication means, etc.) may be used based on these positioning schemes.

[LTE Positioning Protocol]

In the LTE system, an LPP (LTE positioning protocol) has been defined to the OTDOA scheme, and notifies the UE of OTDOA-ProvideAssistanceData having the following configuration through IE (information element).

| -- ASN1START | |
|---|---|
| OTDOA-ProvideAssistanceData ::= SEQUENCE { | |
| otdoa-ReferenceCellInfoOTDOA-ReferenceCellInfo | OPTIONAL, |

-- Need ON

| | |
|---|---|
| otdoa-NeighbourCellInfo | OTDOA-NeighbourCellInfoList |

OPTIONAL, -- Need ON

| | |
|---|---|
| otdoa-Error | OTDOA-Error OPTIONAL, -- Need ON |

...
}
-- ASN1STOP

In this case, OTDOA-ReferenceCellInfo means a cell which is a reference of RSTD measurement, and is configured as follows.

| -- ASN1START | | | |
|---|---|---|---|
| OTDOA-ReferenceCellInfo ::= SEQUENCE { | | | |
| physCellId | INTEGER (0..503), | | |
| cellGlobalId | ECGI OPTIONAL, | -- Need ON | |
| earfcnRef | ARFCN-ValueEUTRA | OPTIONAL, | --Cond |

NotSameAsServ0

| | |
|---|---|
| antennaPortConfig | ENUMERATED {ports1-or-2, ports4, ... } |

| | |
|---|---|
| OPTIONAL, | -- Cond NotSameAsServ1 |

| cpLength ENUMERATED { normal, extended, ... }, | | |
|---|---|---|
| prsInfo PRS-Info | OPTIONAL, | -- Cond PRS |

| ..., | | |
|---|---|---|
| [[ earfcnRef-v9a0 | ARFCN-ValueEUTRA-v9a0 | OPTIONAL |

-- Cond NotSameAsServ2

]]
}
-- ASN1STOP

Meanwhile, OTDOA-NeighbourCellInfo means cells (for example, eNB or TP) which is a target for RSTD measurement, and may include information on maximum 24 neighboring cells per frequency layer with respect to maximum three frequency layers. That is, OTDOA-NeighbourCellInfo may notify the UE of information on a total of 3*24=72 cells.

| -- ASN1START | | | |
|---|---|---|---|
| OTDOA-NeighbourCellInfoList | ::= | SEQUENCE | (SIZE |

(1..maxFreqLayers)) OF OTDOA-NeighbourFreqInfo

OTDOA-NeighbourFreqInfo ::= SEQUENCE (SIZE (1..24)) OF

OTDOA-NeighbourCellInfoElement

| OTDOA-NeighbourCellInfoElement ::= SEQUENCE { | | | |
|---|---|---|---|
| physCellId | INTEGER (0..503), | | |
| cellGlobalId | ECGI | OPTIONAL, | -- Need ON |

| | | |
|---|---|---|
| earfcn ARFCN-ValueEUTRA OPTIONAL, | -- | Cond |

NotSameAsRef0

| | |
|---|---|
| cpLength | ENUMERATED {normal, extended, ...} |
| OPTIONAL, | -- Cond NotSameAsRef1 |

| | | | |
|---|---|---|---|
| prsInfo PRS-Info | OPTIONAL, | -- | Cond |

NotSameAsRef2

| antennaPortConfig | ENUMERATED {ports-1-or-2, ports-4, ...} | | |
|---|---|---|---|
| OPTIONAL, | -- Cond NotsameAsRef3 | | |
| slotNumberOffset | INTEGER (0..19) | OPTIONAL, | -- |

Cond NotSameAsRef4

| | | |
|---|---|---|
| prs-SubframeOffset | INTEGER (0..1279) | OPTIONAL, |

-- Cond InterFreq

| expectedRSTD INTEGER (0..16383), | |
|---|---|
| expectedRSTD-Uncertainty | INTEGER (0..1023), |

| ..., | | |
|---|---|---|
| [[ earfcn-v9a0 | ARFCN-ValueEUTRA-v9a0 | OPTIONAL |

-- Cond NotSameAsRef5

]]
}
maxFreqLayers INTEGER ::= 3
-- ASN1STOP

In this case, PRS-Info which is IE included in OTDOA-ReferenceCellInfo and OTDOA-NeighbourCellInfo has PRS information, and is specifically configured, as follows, as PRS Bandwidth, PRS Configuration Index (IPRS), Number of Consecutive Downlink Subframes, and PRS Muting Information.

PRS-Info ::= SEQUENCE {
prs-Bandwidth ENUMERATED { n6, n15, n25, n50, n75, n100, ... },
prs-ConfigurationIndex INTEGER (0..4095),
numDL-Frames ENUMERATED {sf-1, sf-2, sf-4, sf-6, ...},
...,

| | |
|---|---|
| prs-MutingInfo-r9 | CHOICE { |

| | |
|---|---|
| po2-r9 | BIT STRING (SIZE(2)), |
| po4-r9 | BIT STRING (SIZE(4)), |
| po8-r9 | BIT STRING (SIZE(8)), |

po16-r9 BIT STRING (SIZE(16)),
...

| | |
|---|---|
| } OPTIONAL | -- Need OP |

}
-- ASN1STOP

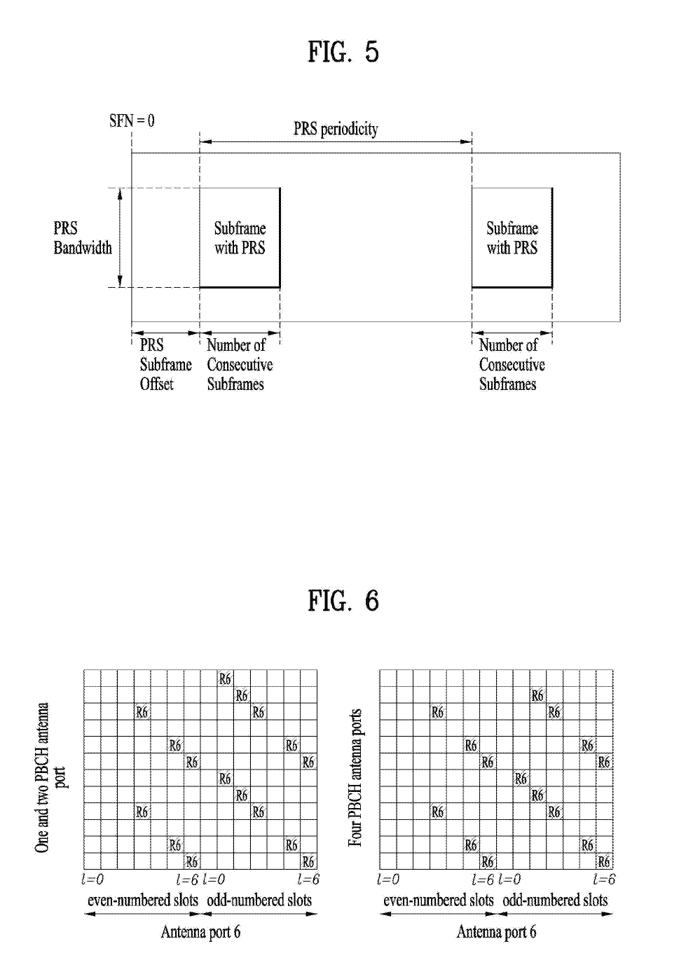

FIG. 5 illustrates a PRS transmission structure according to the above parameters.

At this time, PRS Periodicity and PRS Subframe Offset are determined in accordance with a value of PRS Configuration Index (IPRS), and their correlation is as follows.

TABLE 5

| PRS Configuration Index | PRS Periodicity | PRS Subframe Offset |
|---|---|---|
| (I_{PRS}) | (subframes) | (subframes) |
| 0-159 | 160 | I_{PRS} |
| 160-479 | 320 | I_{PRS} − 160 |
| 480-1119 | 640 | I_{PRS} − 480 |
| 1120-23399 | 1280 | I_{PRS} − 1120 |

[PRS (Positioning Reference Signal)]

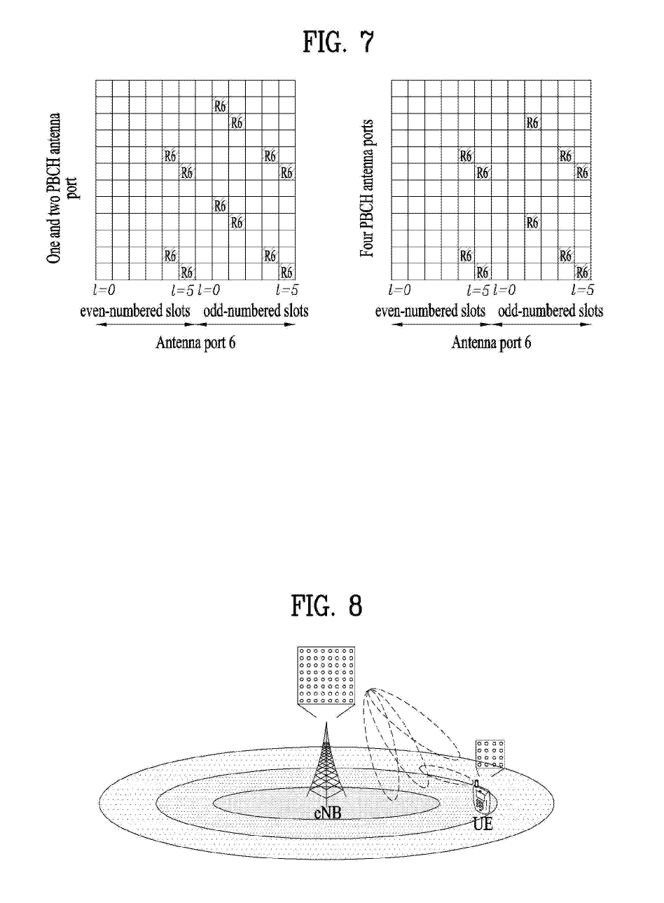

The PRS has a transmission occasion, that is, a positioning occasion at a period of 160, 320, 640, or 1280 ms, and may be transmitted for N DL subframes consecutive for the positioning occasion. In this case, N may have a value of 1, 2, 4 or 6. Although the PRS may be transmitted substantially at the positioning occasion, the PRS may be muted for inter-cell interference control cooperation. Information on such PRS muting is signaled to the UE as prs-MutingInfo. A transmission bandwidth of the PRS may be configured independently unlike a system bandwidth of a serving eNB, and is transmitted to a frequency band of 6, 15, 25, 50, 75 or 100 resource blocks (RBs). Transmission sequences of the PRS are generated by initializing a pseudo-random sequence generator for every OFDM symbol using a function of a slot index, an OFDM symbol index, a cyclic prefix (CP) type, and a cell ID. The generated transmission sequences of the PRS are mapped to resource elements (REs) depending on a normal CP or an extended CP as shown in FIG. 6 (normal CP) and FIG. 7 (extended CP). A position of the mapped REs may be shifted on the frequency axis, and a shift value is determined by a cell ID. The positions of the REs for transmission of the PRS shown in FIGS. 6 and 7 correspond to the case that the frequency shift is 0.

The UE receives designated configuration information on a list of PRSs to be searched from a position management server of a network to measure PRSs. The corresponding information includes PRS configuration information of a reference cell and PRS configuration information of neighboring cells. The configuration information of each PRS includes a generation cycle and offset of a positioning occasion, and the number of continuous DL subframes constituting one positioning occasion, cell ID used for generation of PRS sequences, a CP type, the number of CRS antenna ports considered at the time of PRS mapping, etc. In addition, the PRS configuration information of the neighboring cells includes a slot offset and a subframe offset of the neighboring cells and the reference cell, an expected RSTD, and a level of uncertainty of the expected RSTD to support determination of the UE when the UE determines a timing point and a level of time window used to search for the PRS to detect the PRS transmitted from the neighboring cell.

Meanwhile, the RSTD refers to a relative timing difference between an adjacent or neighboring cell j and a reference cell i. In other words, the RSTD may be expressed by T_{subframeRxj}−T_{subframeRxi}, wherein T_{subframeRxj} refers to a timing point at which a UE starts to receive a specific subframe from the neighboring cell j, and T_{subframeRxi} refers to a timing point at which a UE starts to receive a subframe, which is closest to the specific subframe received from the neighboring cell j in terms of time and corresponds to the specific subframe, from the reference cell i. A reference point for an observed subframe time difference is an antenna connector of the UE.

Although the aforementioned positioning schemes of the related art are already supported by the 3GPP UTRA and E-UTRAN standard (for example, (LTE Rel-9), higher accuracy is recently required for an in-building positioning scheme. That is, although the positioning schemes of the related art may commonly be applied to outdoor/indoor environments, in case of E-CID scheme, general positioning accuracy is known as 150 m in a non-LOS (NLOS) environment and as 50 m in a LOS environment. Also, the OTDOA scheme based on the PRS has a limit in a positioning error, which may exceed 100 m, due to an eNB synchronization error, a multipath propagation error, a quantization error in RSTD measurement of a UE, and a timing offset estimation error. Also, since a GNSS receiver is required in case of the A-GNSS scheme, the A-GNSS scheme has a limit in complexity and battery consumption, and has a restriction in using in-building positioning.

Basically, the present invention considers a method for an eNB to calculate location information of a UE in a manner that a cellular network transmits a specific pilot signal to the UE, the UE calculates a positioning-related estimation value using a specific positioning scheme by measuring the pilot signal (e.g., reporting OTDOA and RSTD estimation value), and the UE reports the calculated value to the eNB.

An evolved wireless communication system considers introducing an active antenna system (hereinafter, AAS). Since the AAS supports an electronic beam control scheme according to each antenna, the AAS enables an evolved MIMO technique such as forming a delicate beam pattern in consideration of a beam direction and a beam width, forming a 3D beam pattern, and the like. As the evolved antenna system such as the AAS and the like is introduced, a massive MIMO structure including a plurality of input/output antennas and multi-dimensional antenna structure is also considered. As an example, in case of forming a 2D antenna array instead of a legacy straight antenna array, it may be able to form a 3D beam pattern according to the active antenna of the AAS.

In the aspect of a transmission antenna, if the 3D beam pattern is utilized, the transmission antenna may form a semi-static or dynamic beam not only in horizontal direction but also in a vertical direction. For example, it may consider an application such as forming a sector in vertical direction, and the like. Moreover, in the aspect of a reception antenna, when a reception beam is formed by utilizing a massive antenna, the reception antenna may expect a signal power synergy effect according to an antenna array gain. Hence, in case of UL, an eNB can receive a signal transmitted by a UE via a plurality of antennas. In this case, the UE can configure transmit power of the UE to be very low in consideration of a gain of a massive reception antenna to reduce interference impact. FIG. 8 shows an example of the aforementioned antenna system. FIG. 8 shows a system that an eNB or a UE has a plurality of transmission/reception antennas capable of forming an AAS-based 3D beam.

As mentioned in the foregoing description, a legacy GPS-based technique or a legacy measurement-based positioning technique has a limit in obtaining positioning accuracy for a vertical location of an indoor UE. A massive MIMO system capable of forming a 3D beam pattern transmits a precoded RS and performs RRM (radio resource management) on the precoded RS. By doing so, it may be able to increase accuracy of estimating a vertical location of an indoor UE.

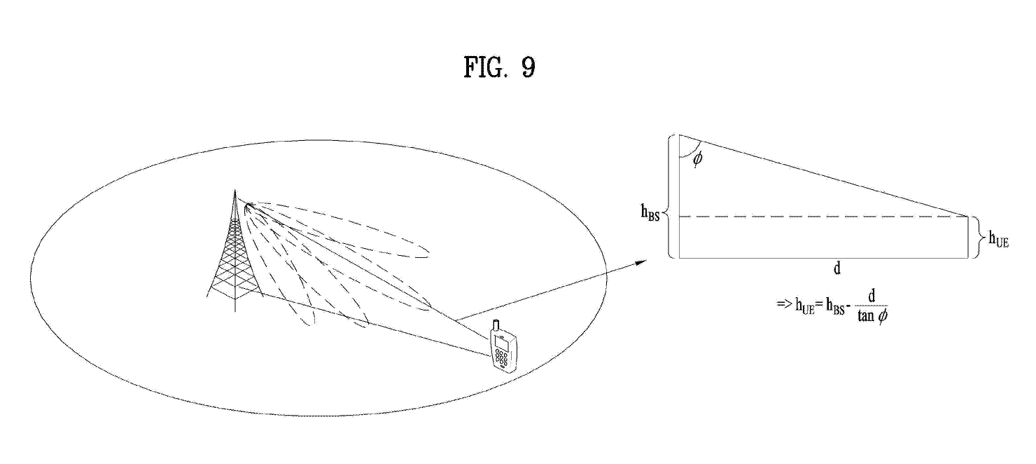

For example, when a vertical location of a UE is estimated using a legacy technique, if an RS to which a 3D beam pattern is variously applied is transmitted to the UE and the UE performs RRM measurement on the RS, the UE can select a beam having a most dominant average power level and an eNB or a TP (transmission point) transmitting the beam. In particular, as shown in FIG. 9, a location server can estimate a vertical location of a UE using the equation described in the following.

$${h}_{UE} = {h}_{BS} - \frac{d}{tan φ} \qquad [ Equation 1 ]$$

However, it is apparent that the contents of the present invention can be applied not only to vertical positioning but also to positioning of a UE that utilizes RRM measurement on a precoded RS having a 3D beam pattern.

According to LTE standard, an eNB can provide configuration information (e.g., DMTC) on a specific RS (e.g., CSI-RS for the purpose of discovery) to a UE. In this case, in case of an eNB capable of managing a massive MIMO system capable of forming the 3D beam pattern, it may be able to configure the eNB to apply a different precoding to each CSI-RS and report on a result of RRM measurement performed on each CSI-RS. More specifically, the eNB transmits each of a plurality of RSs to which a different precoding is applied based on the configuration information on the RS and a UE can individually report on an average power level (e.g., CSI-RSRP (reference signal received power) of each of the precoded RSs. It may be able to identify not only an eNB/TP closest to the UE among eNBs/TPs transmitting an RS but also a beam direction having the highest metric among the precoded RSs based on the report to more accurately estimate a location. It may use measurement corresponding to a beam direction of a specific eNB/TP. Yet, if it is able to utilize measurement on a plurality of beam directions of a plurality of eNBs/TPs and selectively use and correct the measurement in estimating a location, it may be able to more enhance positioning performance.

To this end, it is necessary for a location server to know whether or not an eNB/TP has capability capable of transmitting a precoded RS. Hence, the eNB/TP can provide capability signaling to the location server (e.g., E-SMLC (enhanced serving mobile location center), SLP (SUPL location platform, etc.)) to indicate whether or not the eNB/TP has capability capable of transmitting a precoded RS (e.g., LPPa protocol). In addition, the eNB/TP can also provide the location server with information on the number of precoded RSs (type of beam direction), an identifier of each of precoded RSs, and the like. And, a specific eNB/TP can provide the location server with information (e.g., equation 1 or FIG. 9) on a beam applied to each of precoded RSs transmitted by the specific eNB/TP and a corresponding identifier. And, the eNB/TP can also provide the location server with information on transmit power of a corresponding RS and separate parameters capable of inducing power of the RS. Or, the eNB can provide the abovementioned information to a UE.

A UE can report on capability of the UE to a location server (or an eNB) via physical layer signaling or higher layer signaling to indicate whether or not the UE is able to measure a precoded RS. By doing so, the location server can determine whether to estimate a location using the precoded RS. And, the location server can ask the UE to perform measurement on a specific precoded RS of a specific eNB/TP. Or, the location server may ask the UE to perform measurement on a specific precoded RS of a specific eNB/TP in a specific time domain and/or frequency domain.

Or, the specific eNB/TP can configure the UE to perform measurement on the specific precoded RS. Or, the specific eNB/TP can configure the UE to perform measurement on the specific precoded RS in a specific time domain and/or frequency domain.

In this case, the location server can configure the UE to selectively report on a measurement result for “the specific number of eNBs/TPs” to the location server. Or, the location server can configure the UE to selectively report on a measurement result for “the specific number of RSs” or “a specific RS” to each eNB/TP. Or, a specific eNB/TP can configure the UE to selectively report on a measurement result for “the specific number of RSs” or “a specific RS” to each eNB/TP.

The UE performs RS measurement on a plurality of RSs transmitted by a specific eNB/TP and can report on all of a plurality of the RSs to the specific eNB/TP. Or, the UE performs measurement on each of a plurality of the RSs transmitted by the specific eNB/TP and selects one or a part of a plurality of the RSs to report on a measurement result of the selected RSs. For example, the UE performs RS measurement on a plurality of RSs and may be able to report on one or a part of the RSs of which signal strength or signal quality (average power level/SNR (signal-to-noise ratio)/SINR (signal-to-interference plus noise ratio) is high to the location server or a network.

When a UE performs measurement on a precoded RS transmitted by a specific eNB capable of transmitting precoded RS and reports on a measurement result to a location server, it is necessary for the location server to recognize that a result of RRM measurement corresponds to a result received from the specific eNB. Hence, it is necessary to perform mapping between a specific precoded RS and a measurement report on the specific precoded RS. To this end, when an eNB configures a UE to perform RRM measurement on a precoded RS, the eNB can signal a mapping relation to the UE. And, the eNB can signal the mapping relation to the location server as well.

If the UE is able to know the mapping relation, when the UE reports on RRM measurement for a precoded RS, the UE can also signal an indicator indicating the mapping relation between a measurement result and an eNB/TP.

However, RRM measurement for a UE-transparent precoded RS can be configured while the UE is unaware of the mapping relation. Hence, when the UE reports on a measurement result to the location server, the UE can also report on a field corresponding to an ID (e.g., MeasCSI-RS-Id-r12) of the RS to the location server. The location server can identify a measurement report on a plurality of precoded RSs transmitted by a specific eNB/TP through the ID information of the RS.

Or, when the UE reports on a measurement result to an eNB, the UE can also report on a field corresponding to an ID (e.g., MeasCSI-RS-Id-r12) of a corresponding RS to the eNB.

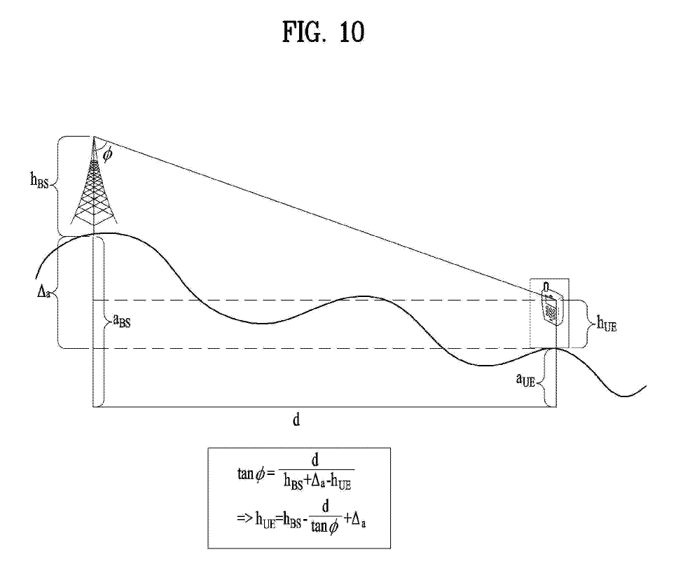

If an altitude above sea level of a specific eNB is not identical to an altitude above sea level of a UE, accuracy of a location estimation method shown in equation 1 can be reduced. For example, as shown in FIG. 10, if there is a difference in the altitude above sea level between the specific eNB and the UE, a location sever deducts the altitude above sea level of the UE from an estimated horizontal location of the UE, corrects the difference in the altitude above sea level between the specific eNB and the UE, and may be able to estimate a location of the UE based on the equation described in the following.

$$tan φ = \frac{d}{{h}_{BS} + {Δ}_{a} - {h}_{UE}} \\ ⇒ {h}_{UE} = {h}_{BS} - \frac{d}{tan φ} + {Δ}_{a} \qquad [ Equation 2 ]$$

Meanwhile, according to a different embodiment of the present invention, an eNB/TP can perform a plurality of measurements on an uplink signal of a UE by performing reception beamforming utilizing a 3D beam pattern in the aspect of a reception antenna. For example, it may be able to differently configure a vertical beam direction of a plurality of received beams received by the reception beamforming.

The eNB/TP can provide capability signaling to the location server (e.g., E-SMLC (enhanced serving mobile location center), SLP (SUPL location platform, etc.)) to indicate whether or not the eNB/TP has capability capable of performing reception beamforming (e.g., LPPa protocol). In addition, the eNB/TP can also provide the location server with information on the number of reception beam directions (type of beam direction), reception direction information on each of reception beams, and an identifier of each of the reception beams, and the like.

The location server can configure the eNB/TP to selectively report on a measurement result for “the specific number of UEs” or “specific UEs”. The location server can configure the eNB/TP to selectively report on a measurement result corresponding to “the specific number of reception beams” or “a specific reception beam” only.

The eNB/TP applies a plurality of reception beamforming to an uplink signal of a UE, performs measurement on each of a plurality of the reception beamforming (if necessary, together with an identifier for each of a plurality of the reception beamforming), and reports on a measurement result to the location server. Or, the eNB/TP performs measurement on each of a plurality of the reception beamforming and may report on one or a part of a plurality of the reception beamforming. In this case, the measurement can be performed on signal strength such as an average (or instantaneous) power level/SNR/SINR, signal quality, and/or timing/angle of a signal (e.g., TOA (time of arrival), AOA (angle of arrival), or a combination thereof.

Since it is able to include the examples for the proposed method as one of implementation methods of the present invention, it is apparent that the examples are considered as a sort of proposed methods. Although the embodiments of the present invention can be independently implemented, the embodiments can also be implemented in a combined/aggregated form of a part of embodiments. It may define a rule that an eNB/location server informs a UE of information on whether to apply the proposed methods (or, information on rules of the proposed methods) via a predefined signal (e.g., physical layer signal or higher layer signal).

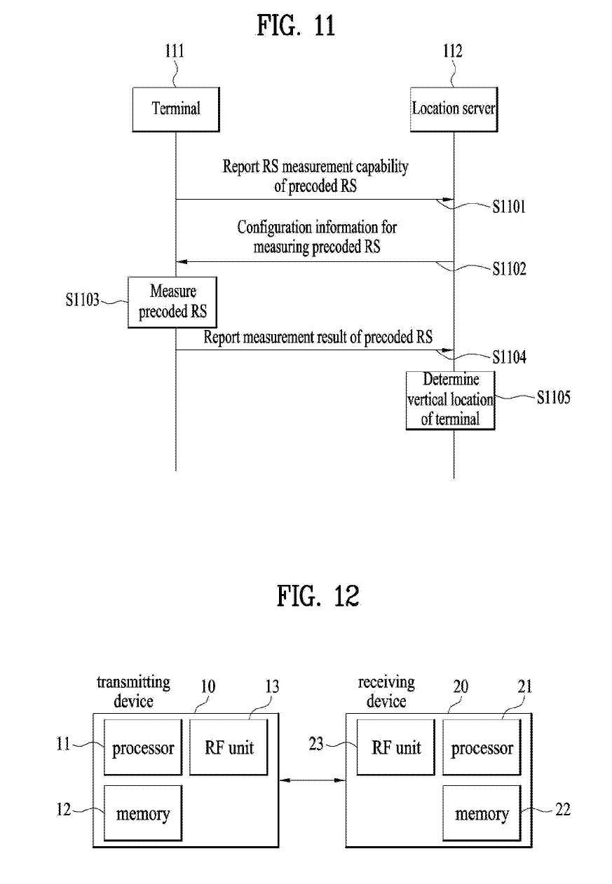

FIG. 11 is a flowchart for an operation according to an embodiment of the present invention.

FIG. 11 shows a method for a terminal to measure a reference signal for positioning in a wireless communication system.

A terminal 111 may transmit a report on measurement capability of a precoded reference signal (RS) for determining a vertical position of the terminal to a location server 112 [S1101]. The terminal may receive configuration information for measuring the precoded RS from the location server [S1102]. The terminal may measure the precoded RS according to the configuration information [S1103]. Subsequently, the terminal may report on a result of the measurement to the location server [S1104]. The configuration information may include information on a time or frequency domain in which the precoded RS is to be measured by the terminal, a base station which transmits the precoded RS to be reported by the terminal, and the precoded RS to be reported by the terminal.

The UE may receive the configuration information on the precoded RS from a serving base station. The configuration information on the precoded RS may include an identifier of an base station which transmits the precoded RS. The identifier of the base station may be transmitted together when the measurement result of the precoded RS is reported. Or, the identifier of the base station may be transmitted separately. The identifier of the base station may be used for mapping a measurement result of a specific precoded RS received from the terminal with an base station, which has transmitted the specific precoded RS.

The configuration information on the precoded RS may be provided to the location server by the base station which transmits the precoded RS.

The location server may obtain information on a vertical beam applied to the precoded RS from the base station which transmits the precoded RS and a vertical position of the terminal may be calculated based on the information on the vertical beam [S1105].

In the foregoing description, the embodiments of the present invention have been briefly explained with reference to FIG. 11. An embodiment related to FIG. 11 may alternatively or additionally include at least a part of the aforementioned embodiment(s).

FIG. 12 is a block diagram illustrating a transmitter 10 and a receiver 20 configured to implement embodiments of the present invention. Each of the transmitter 10 and receiver 20 includes a radio frequency (RF) unit 13, 23 capable of transmitting or receiving a radio signal that carries information and/or data, a signal, a message, etc., a memory 12, 22 configured to store various kinds of information related to communication with a wireless communication system, and a processor 11, 21 operatively connected to elements such as the RF unit 13, 23 and the memory 12, 22 to control the memory 12, 22 and/or the RF unit 13, 23 to allow the device to implement at least one of the embodiments of the present invention described above.

The memory 12, 22 may store a program for processing and controlling the processor 11, 21, and temporarily store input/output information. The memory 12, 22 may also be utilized as a buffer. The processor 11, 21 controls overall operations of various modules in the transmitter or the receiver. Particularly, the processor 11, 21 may perform various control functions for implementation of the present invention. The processors 11 and 21 may be referred to as controllers, microcontrollers, microprocessors, microcomputers, or the like. The processors 11 and 21 may be achieved by hardware, firmware, software, or a combination thereof. In a hardware configuration for an embodiment of the present invention, the processor 11, 21 may be provided with application specific integrated circuits (ASICs) or digital signal processors (DSPs), digital signal processing devices (DSPDs), programmable logic devices (PLDs), and field programmable gate arrays (FPGAs) that are configured to implement the present invention. In the case which the present invention is implemented using firmware or software, the firmware or software may be provided with a module, a procedure, a function, or the like which performs the functions or operations of the present invention. The firmware or software configured to implement the present invention may be provided in the processor 11, 21 or stored in the memory 12, 22 to be driven by the processor 11, 21.

The processor 11 of the transmitter 10 performs predetermined coding and modulation of a signal and/or data scheduled by the processor 11 or a scheduler connected to the processor 11, and then transmits a signal and/or data to the RF unit 13. For example, the processor 11 converts a data sequence to be transmitted into K layers through demultiplexing and channel coding, scrambling, and modulation. The coded data sequence is referred to as a codeword, and is equivalent to a transport block which is a data block provided by the MAC layer. One transport block is coded as one codeword, and each codeword is transmitted to the receiver in the form of one or more layers. To perform frequency-up transformation, the RF unit 13 may include an oscillator. The RF unit 13 may include Nt transmit antennas (wherein Nt is a positive integer greater than or equal to 1).

The signal processing procedure in the receiver 20 is configured as a reverse procedure of the signal processing procedure in the transmitter 10. The RF unit 23 of the receiver 20 receives a radio signal transmitted from the transmitter 10 under control of the processor 21. The RF unit 23 may include Nr receive antennas, and retrieves baseband signals by frequency down-converting the signals received through the receive antennas. The RF unit 23 may include an oscillator to perform frequency down-converting. The processor 21 may perform decoding and demodulation on the radio signal received through the receive antennas, thereby retrieving data that the transmitter 10 has originally intended to transmit.

The RF unit 13, 23 includes one or more antennas. According to an embodiment of the present invention, the antennas function to transmit signals processed by the RF unit 13, 23 are to receive radio signals and deliver the same to the RF unit 13, 23. The antennas are also called antenna ports. Each antenna may correspond to one physical antenna or be configured by a combination of two or more physical antenna elements. A signal transmitted through each antenna cannot be decomposed by the receiver 20 anymore. A reference signal (RS) transmitted in accordance with a corresponding antenna defines an antenna from the perspective of the receiver 20, enables the receiver 20 to perform channel estimation on the antenna irrespective of whether the channel is a single radio channel from one physical antenna or a composite channel from a plurality of physical antenna elements including the antenna. That is, an antenna is defined such that a channel for delivering a symbol on the antenna is derived from a channel for delivering another symbol on the same antenna. An RF unit supporting the Multiple-Input Multiple-Output (MIMO) for transmitting and receiving data using a plurality of antennas may be connected to two or more antennas.

In embodiments of the present invention, the UE operates as the transmitter 10 on uplink, and operates as the receiver 20 on downlink. In embodiments of the present invention, the eNB operates as the receiver 20 on uplink, and operates as the transmitter 10 on downlink.

The transmitter and/or receiver may be implemented by one or more embodiments of the present invention among the embodiments described above.

Detailed descriptions of preferred embodiments of the present invention have been given to allow those skilled in the art to implement and practice the present invention. Although descriptions have been given of the preferred embodiments of the present invention, it will be apparent to those skilled in the art that various modifications and variations can be made in the present invention defined in the appended claims. Thus, the present invention is not intended to be limited to the embodiments described herein, but is intended to have the widest scope consistent with the principles and novel features disclosed herein.

### INDUSTRIAL APPLICABILITY

The present invention is applicable to wireless communication devices such as a terminal, a relay, and a base station.

What is claimed is:

1. A method for measuring a reference signal for positioning, which is performed by a terminal in a wireless communication system, comprising:
transmitting a report on a measurement capability of a precoded reference signal (RS) for determining a vertical position to a location server;
receiving configuration information for measuring the precoded RS from the location server; and
measuring the precoded RS according to the configuration information and reporting on a result of the measurement to the location server,
wherein the configuration information comprises information on a time or frequency domain in which the precoded RS is to be measured by the terminal, a base station which transmits a precoded RS to be reported by the terminal, and the precoded RS to be reported by the terminal.

2. The method of claim 1, further comprising receiving the configuration information for measuring the precoded RS from a serving base station.

3. The method of claim 2, wherein the configuration information for measuring the precoded RS includes an identifier of each base station which transmits a precoded RS.

4. The method of claim 3, wherein the identifier is reported together with a measurement result of the precoded RS.

5. The method of claim 1, further comprising reporting an identifier of the precoded RS measured by the terminal.

6. The method of claim 2, wherein the configuration information for measuring the precoded RS is provided to the location server from each base station which transmits a precoded RS.

7. The method of claim 1, wherein information on a vertical beam applied to the precoded RS is transmitted to the location server and wherein the vertical position of the terminal is calculated based on the information on the vertical beam.

8. A method for positioning, which is performed by a location server in a wireless communication system, comprising:
receiving a report on a measurement capability of a precoded reference signal (RS) for determining a vertical position of a terminal from the terminal;
transmitting configuration information for measuring the precoded RS to the terminal;
receiving a measurement result of the precoded RS measured by the terminal according to the configuration information; and
determining the vertical position of the terminal using the measurement result and information on a vertical beam applied to the precoded RS corresponding to the measurement result,
wherein the configuration information includes information on a time or frequency domain in which the precoded RS is to be measured by the terminal, a base station which transmits a precoded RS to be reported by the terminal, and the precoded RS to be reported by the terminal.

9. The method of claim 8, further comprising receiving the configuration information for measuring the precoded RS from each base station which transmits a precoded RS.

10. The method of claim 9, wherein the configuration information for measuring the precoded RS comprises an identifier of the base station which transmits a precoded RS.

11. The method of claim 8, further comprising receiving information on a vertical beam applied to the precoded RS from each base station which transmits a precoded RS.

12. The method of claim 8, further comprising receiving a report on a transmission capability of the precoded RS from each base station which transmits a precoded RS.

13. The method of claim 8, wherein the measurement result includes an identifier of the base station, which has transmitted the precoded RS measured by the terminal.

14. The method of claim 8, further comprising receiving an identifier of the precoded RS measured by the terminal.

15. A terminal configured to measure a reference signal for positioning in a wireless communication system, comprising:
an radio frequency (RF) unit; and
a processor that controls the RF unit,
wherein the processor controls the RF unit to transmit a report on a measurement capability of a precoded reference signal (RS) for determining a vertical position of the terminal to a location server, controls the RF unit to receive configuration information for measuring the precoded RS from the location server, measures the precoded RS according to the configuration information and reports on a result of the measurement to the location server,
wherein the configuration information comprises information on a time or frequency domain in which the precoded RS is to be measured by the terminal, a base station which transmits a precoded RS to be reported by the terminal, and the precoded RS to be reported by the terminal.

16. A location server configured to determine a location of a terminal in a wireless communication system, comprising:
an radio frequency (RF) unit; and
a processor that controls the RF unit,
wherein the processor controls the RF unit to receive a report on a measurement capability of a precoded reference signal (RS) for determining a vertical position of a terminal from the terminal, controls the RF unit to transmit configuration information for measuring the precoded RS to the terminal, controls the RF unit to receive a measurement result of the precoded RS measured by the terminal according to the configuration information, determines the vertical position of the terminal using the measurement result and information on a vertical beam applied to the precoded RS corresponding to the measurement result,
wherein the configuration information includes information on a time or frequency domain in which the precoded RS is to be measured by the terminal, a base station which transmits a precoded RS to be reported by the terminal, and the precoded RS to be reported by the terminal.
